(19) United States
(12) Patent Application Publication
(10) Pub. No.: US 2015/0239709 A1
(43) Pub. Date: Aug. 27, 2015

(54) DEVICE FOR CHECKING OR ADJUSTING AN ELEVATOR DOOR LOCK

(71) Applicant: INVENTIO AG, Hergiswil (CH)

(72) Inventors: Heinz Kellenberger, Schwarzenbach (CH); Eric Kertész, Riehen (CH)

(21) Appl. No.: 14/431,792

(22) PCT Filed: Aug. 30, 2013
(86) PCT No.: PCT/EP2013/067970

§ 371 Date: Mar. 27, 2015

(30) Foreign Application Priority Data
Sep. 27, 2012 (EP) 12186251.0

(51) Int. Cl. B66B 5/00; B66B 13/20

(52) U.S. Cl. CPC B66B 5/0087; B66B 13/20

(57) ABSTRACT

A device and a method for checking or adjusting a depth of engagement of a locked elevator door lock, wherein the door lock has a catch engaged with a stop, can be fixed to the catch and have a region for supporting the stop. Alternatively, the device can be fixed to the stop and have a region for supporting the catch. The device can be fixed to the catch or to the stop such that a defined depth of engagement is formed when the stop or the catch is resting on the device support region.

### FIELD

The invention relates to a device for checking or adjusting an elevator door lock and to a method for use of this device.

### BACKGROUND

Known elevator installations comprise an elevator shaft, an elevator car movable in the elevator shaft and a plurality of shaft doors. The shaft doors separate individual floors from the elevator shaft. In order to ensure safety of persons present on the floors each individual shaft door is locked. Such a shaft door can be unlocked when the elevator car is at the height of this shaft door. According to the legal standard EN81-1, locking of the shaft door has to precede a subsequent movement of the elevator car. The locking of the shaft door is effected by an elevator door lock with locking elements. Accordingly, the locking elements have to have a defined minimum depth of engagement before the elevator door lock counts as effectively locked.

The elevator door lock usually comprises, in addition to the locking elements, a bridging contact. When the bridging contact is closed, the elevator car can be moved in the elevator shaft. The door lock is usually preset in such a way that this bridging contact is closed only when at least the defined minimum depth of engagement is achieved.

Checking of the minimum depth of engagement usually comprises, in a first working step, positioning of the blocking elements carried out manually in accordance with the minimum depth of engagement, with simultaneous visual checking whether the door contact is opened. This first working step is carried out by the investigating service engineer from the interior of the elevator shaft with shaft door closed. The service engineer subsequently checks, in a second working step, whether unlocking of the relevant shaft door, thus opening of the door contact, produces standstill of the elevator car in the elevator shaft. For this purpose, with the shaft door unlocked in that way, the engineer actuates the elevator control so as to cause movement of the elevator car in the elevator shaft. The service engineer has to carry out this second working step from the floor with the shaft door closed, thus from outside the elevator shaft, so as to be able to ensure his or her own safety. The test of defined minimum depth of engagement is usually regarded as satisfied when the elevator car on the one hand does not move when the shaft door is unlocked in that way and on the other hand moves when the shaft door is locked.

Alternatively, the service engineer can carry out the check of minimum depth of engagement from the elevator car. On the one hand, manual unlocking of the shaft door with simultaneous actuation of the elevator control by means of a panel arranged on a car roof of the elevator car could lead to movement of the elevator car, in which case the service engineer consequently present on the elevator car operates the shaft door by one hand. This can disadvantageously lead to injury of the service engineer if his or her hand is jammed at the shaft door, but the elevator car moves onward.

On the other hand, checking of the minimum amount of engagement is very time-intensive if the service engineer has to carry out a part of the check from the interior of the elevator shaft and a further part of the check from the floor.

### SUMMARY

The invention has an object of minimizing the expenditure of time for checking or adjusting the elevator door lock and in that case of excluding risk to the service engineer.

The object is fulfilled by a device for checking or adjusting a depth of engagement of a locked elevator door lock, wherein the locked elevator door lock comprises a catch and a stop disposed in engagement with the catch, wherein the device is attachable to the catch and has a region for support of the stop or the device is attachable to the stop and has a region for support of the catch, and the device is so attachable to the catch or stop that when the stop or catch rests on the region, which is constructed for support thereof, of the device a defined depth of engagement is formed.

The object is also fulfilled by a method for checking or adjusting a depth of engagement of an elevator door lock, comprising the following method steps:

attaching a device for a catch or a stop of the elevator door lock,

positioning the stop or the catch on a region of the device for support of the stop or the catch and

checking a defined depth of engagement by means of a bridging contact of the elevator door lock.

When checking or adjusting the depth of engagement the service engineer intervenes directly in the locking elements of the elevator door lock, for example the elevator door lock of a shaft door. In the case of checking or adjusting the elevator door lock of the shaft door the service engineer is then located on or in the elevator car. During this check or adjustment a test is carried out as to whether the bridging contact is closed and thus the elevator door lock effectively locked. This test can have the consequence that the elevator car moves in the elevator shaft.

The invention is based on recognition that these actions previously carried out at least partly at the same time—intervention in the locking elements and the test—are completely separable in terms of time. This is achieved in that the depth of engagement of the locking elements is preset by the service engineer to a defined dimension and only then is the test carried out. It is thus achieved that the service engineer can carry out both actions from the elevator car without in that case a risk of injury for the engineer. A presetting of that kind is made possible by means of the device for checking or adjusting the depth of engagement.

In a development of the invention the defined depth of engagement corresponds with a test dimension. This test dimension is equal to the minimum depth of engagement or less, preferably substantially less, than the minimum depth of engagement. In this way it can be checked whether the elevator door lock corresponds with the requirements for a possible legal minimum depth of engagement. In an alternative to this development of the device the defined depth of engagement corresponds with a desired dimension, wherein the desired dimension is greater than the minimum depth of engagement. In that way it is possible to preset a depth of engagement of the elevator door lock which is ultimately greater than the minimum depth of engagement. In the case of wear of the locking elements in a period of time following the test or the adjustment it can thus be ensured that the depth of engagement during this period of time corresponds with the preset minimum depth of engagement and thus produces effective locking of the elevator door lock.

In a development of the device the depth of engagement is variable. In that way the device can be adapted to the testing or adjusting requirements of different elevator door locks so that the service engineer merely has to carry a single device for the elevator door locks to be checked or adjusted in a period of time.

A development of the device comprises an attachment region for attachment of the device to the catch or to the stop. Handling of the device can be simplified or a working procedure for checking or adjustment of the depth of engagement can be accelerated by means of this attachment region. This attachment region can be constructed as a plugging or clamping device so that the device can be plugged onto or clamped to the catch or the stop. A development of the attachment region is formed as an adhesion surface, preferably as a magnet, so that the device adheres to the catch or the stop. Thus, various exemplifying possibilities for attachment of the device to the elevator door lock, which are of simple concept, are given. In that case, the attachment region can be a reference attachment region which has a spacing, which is predetermined by the test dimension or by the desired dimension, from the region for support so that the device is attachable to the catch or the stop by means of the reference attachment region. In that way it is possible for the setting of a previously defined depth of engagement to be able to be set or read off directly at the device. This possibility is given by a spacing of a region for support of the locking element from such a reference attachment region, because the two stated regions delimit the amount of the defined depth of engagement.

In a development of the method, checking of the defined depth of engagement is carried out by means of actuation of an elevator control. In that way a check is possible as to whether the elevator door lock fulfils the requirements of the defined depth of engagement.

### DESCRIPTION OF THE DRAWINGS

The invention is explained in more detail in the following by way of figures, in which:

FIG. 1 shows an elevator door with an elevator door lock;

FIG. 2 shows a perspective illustration of the elevator door lock;

FIG. 3 shows an elevator door lock with a first device for checking or adjusting a minimum depth of engagement;

FIG. 4 shows an elevator door lock with a second device for checking or adjusting a minimum depth of engagement; and

FIG. 5 shows a third device for checking or adjusting a depth of engagement.

### DETAILED DESCRIPTION

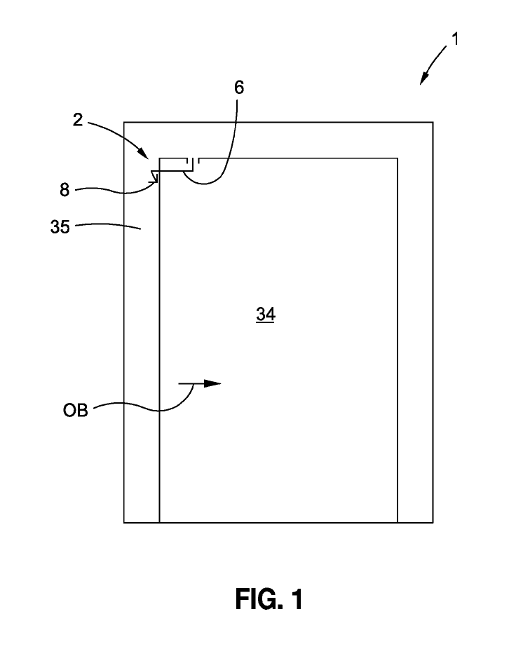

FIG. 1 shows an elevator door 1 with an elevator door lock 2. The elevator door 1, namely a shaft door or a car door, can be arranged in an elevator installation (not illustrated). The elevator door 1 comprises a door leaf 34 and a door surround 35. The elevator door lock 2 comprises locking elements 6, 8 and a bridging contact (not illustrated). The locking elements 6, 8 are a stop 8 and a catch 6. The catch 6 is pivotable and can be arranged at the door leaf 34 or at the door surround 35. The stop 8 is arranged at the door surround 35 when the catch 6 is arranged at the door leaf 34, and vice versa. When the elevator door 2 is locked, the catch 6 and the stop 8 are in mutual engagement, whereby an opening movement OB of the door leaf 34 is prevented.

Instead of an arrangement of the catch 6 or the stop 8 at the door surround 35, the catch 6 or the stop 8 can be arranged in one form of embodiment, which is not illustrated, at an additional door leaf, wherein locking of the elevator door lock 2 prevents opening movement not only of the door leaf 34, but also of the additional door leaf.

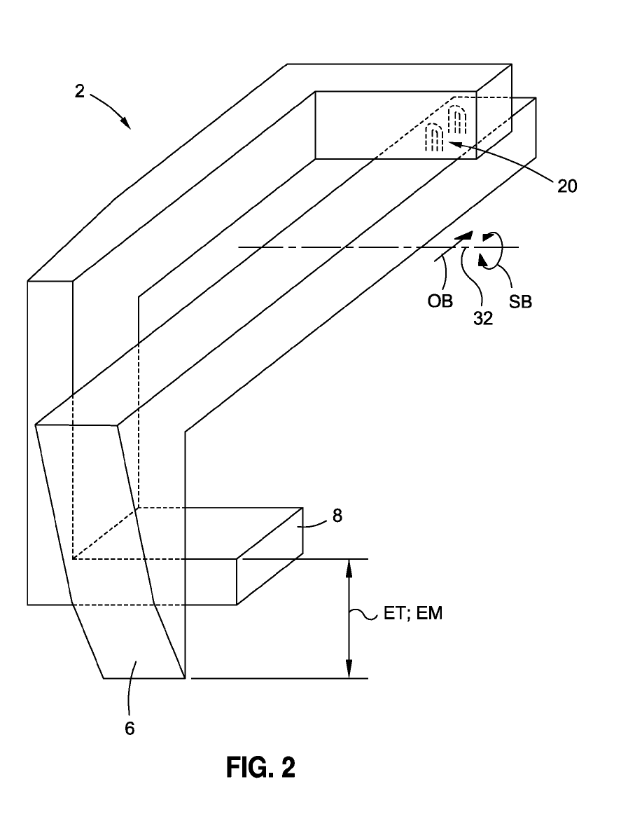

FIGS. 2 to 4 show an elevator door lock 2 described in accordance with FIG. 1, in which FIG. 2 is a perspective illustration. The reference numeral 20 is allocated to the bridging contact of the elevator door lock 2. The catch 6 can execute a pivot movement SB about an axis 32 of rotation. When the elevator door lock 2 is locked the catch 6 is in engagement with the stop 8 and the elevator door lock 2 has a depth of engagement ET, which prevents an opening movement OB (see FIG. 2) of the elevator door. If this depth of engagement ET reaches or exceeds a minimum depth of engagement EM the bridging contact 20 is closed. An opened bridging contact 20 has the effect, notwithstanding engagement of the catch 6 and the stop 8, that the elevator door lock 2 does not count as effectively locked. In the case of ineffective locking an elevator car (not illustrated) should not move. The dimension of the depth of engagement ET is preferably oriented perpendicularly to the direction of opening movement OB of the elevator door.

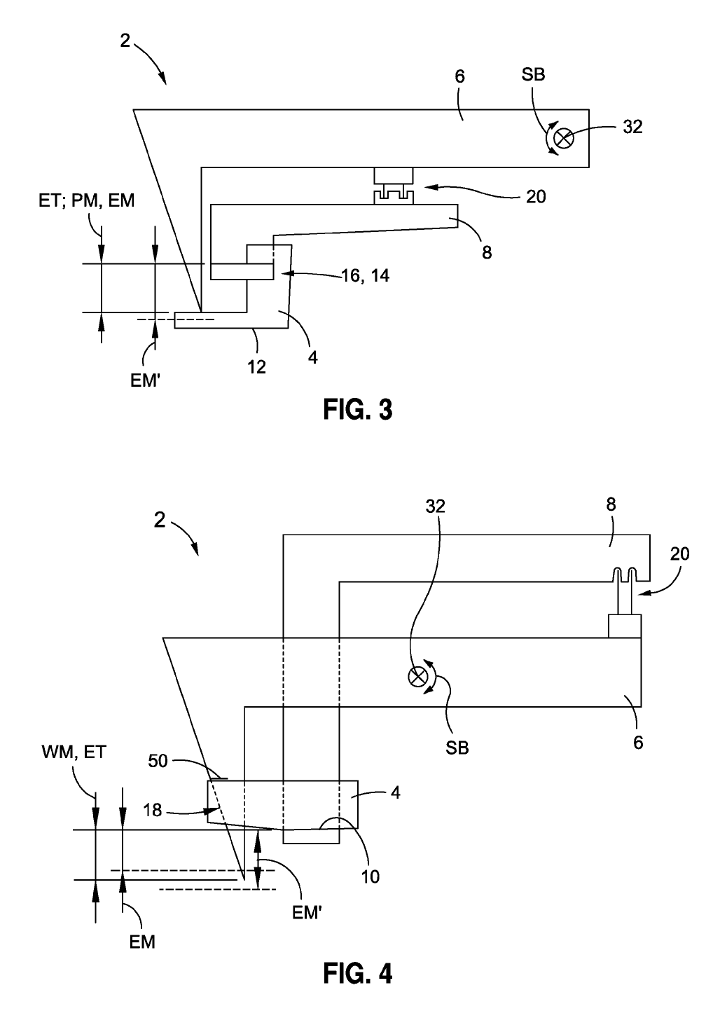

FIGS. 3 and 4 show an elevator door lock 2 described in accordance with FIG. 1 and a device 4 for checking or adjusting the depth of engagement ET. The device 4 is attachable to a first one of the locking elements 6, 8 and can, for this purpose, comprise an attachment region 16, 18. The ability to attach the device 4 to a first one of the locking elements 6, 8 equally comprises the possibility of being able to attach the device 4 to a part of the elevator door, in which case this part of the elevator door is attached to one of the locking elements 6, 8, Such an attachment region 16, 18 can be formed as a reference attachment region 14 (FIG. 3) and/or as a clamping or plugging device 16 (FIG. 3) and/or as an adhesion surface 18 (FIG. 4), preferably as a magnet.

The device 4 has a region 10, 12 for support of a second one of the locking elements 8, 6. When the catch 6 or the stop 8 rests on this region 10, 12 the elevator door lock 2 forms a defined depth of engagement ET. For example, the catch 6 and/or the stop 8 can have a marking 50 (FIG. 4) so as to enable simplified positioning of the device 4 before the device 4 can be attached to the catch 6 or stop 8.

The device 4 shown in FIG. 3 enables checking or adjustment of the depth of engagement ET by means of a test dimension PM, wherein in the illustrated example of FIG. 3 the depth of engagement ET corresponds not only with the test dimension PM, but also with the minimum depth of engagement EM. A spacing of the reference attachment region 14 from the region 12 for support is accordingly selected in correspondence with the minimum depth of engagement EM.

The device 4 shown in FIG. 4 enables checking or adjustment of the depth of engagement ET by means of a desired dimension WM, in which case the desired dimension WM is greater than the minimum depth of engagement EM or can be equal to the minimum depth of engagement EM.

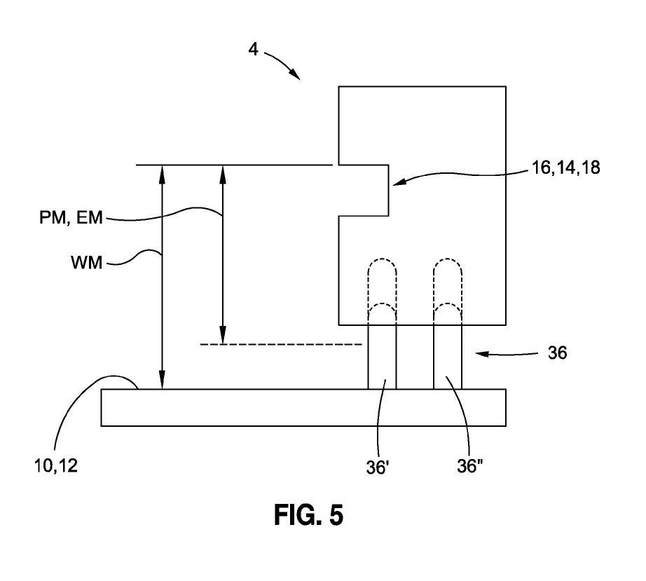

A device 4, which is shown in FIG. 5, for checking or adjusting a depth of engagement ET can comprise the features of the devices shown in FIGS. 3 and 4. In addition, the device 4 can be constructed in such a way that a depth of engagement, which can be checked or adjusted by means of this device 4 at an elevator door lock, is variable. For this purpose the device 4 comprises a variation device 36 with an adjusting element 36″. In addition, the variation device 36 can comprise a guide element 36′. By means of the adjusting element 36″ and optional guide element 36′ a spacing of the attachment region 16, 18, which can be formed as a reference attachment region 14, from the region 10, 12 for support is variable and presettable. Accordingly, an increased accuracy in the setting of this spacing is achievable by means of the guide element 36′.

When checking or adjusting the depth of engagement ET, the device 4 is attached to the first locking element 6, 8 and the second locking element 8, 6 is positioned on the region 10, 12 for support of this second locking element 8, 6. The depth of engagement ET defined by means of the device 4, which depth of engagement ET can be a desired dimension WM or a test dimension PM, is checked by means of the bridging contact 20. The method step to be carried out by means of the bridging contact 20 is preferably undertaken subsequently to attachment of the device 4 to the elevator door lock 2 and positioning of the second locking element 6, 8 at the device 4. The checking by means of the bridging contact 20 can be carried out in such a way by actuation of the elevator control that, by way of example, a button is actuated, which can lead to travel of the elevator car. The depth of engagement ET corresponds at least with the previously defined depth of engagement ET when the elevator car, in the case of checking of the defined depth of engagement ET by means of the bridging contact 20, does not move. When the bridging contact 20 is closed the elevator car is movable; when the bridging contact 20 is open the elevator car is not movable. After the conclusion of the checking or adjustment the device 4 can be removed from the elevator door lock 2.

A checking or adjustment of the depth of engagement can, for example, be regarded as successful if the locking elements 6, 8 after checking or adjustment carried out with the help of the device 4 have a higher depth of engagement EM′ (FIGS. 3 and 4) than the depth of engagement ET defined with the help of the device 4 and the elevator car is movable by means of the elevator control.

In accordance with the provisions of the patent statutes, the present invention has been described in what is considered to represent its preferred embodiment. However, it should be noted that the invention can be practiced otherwise than as specifically illustrated and described without departing from its spirit or scope.

1-10. (canceled)

11. A device for checking or adjusting a depth of engagement of a locked elevator door lock, wherein the elevator door lock is arranged at an elevator door and includes a catch and a stop disposed for mutual engagement, comprising:
the device is configured for attachment to the catch and has a support region for supporting the stop, or
the device is configured for attachment to the stop and has the support region for supporting the catch; and
wherein when the elevator door is locked by mutual engagement of the catch and the stop and the device is attached to one of the catch and the stop and another of the stop and the catch rests on the support region, the device indicates a defined depth of engagement and the elevator door lock prevents an opening movement of the elevator door.

12. The device according to claim 11 wherein the defined depth of engagement corresponds with a test dimension and the test dimension is equal to or less than a minimum depth of engagement.

13. The device according to claim 11 wherein the defined depth of engagement corresponds with a desired dimension, wherein the desired dimension is greater than a minimum depth of engagement.

14. The device according to claim 11 including an attachment region for attachment to one of the catch and the stop and wherein a spacing between the attachment region and the support region is variable for selectively setting the defined depth of engagement.

15. The device according to claim 11 including an attachment region for attachment of the device to one of the catch and the stop.

16. The device according to claim 15 wherein the attachment region is formed as a plug device or clamping device for plugging onto or clamping to one of the catch and the stop.

17. The device according to claim 15 wherein the attachment region is formed as an adhesion surface region for adhering to one of the catch and the stop.

18. The device according to claim 17 wherein the adhesion surface is a magnet.

19. The device according to claim 15 wherein the attachment region is a reference attachment region having a spacing, which spacing is predetermined by the defined depth of engagement, from the support region.

20. A method of checking or adjusting a depth of engagement of a locked elevator door lock, comprising the steps of:
attaching a device to one of a catch and a stop of the elevator door lock;
positioning another the catch and the stop on a support region of the device when the catch and the stop are in mutual engagement; and
checking for a defined depth of engagement of the catch with the stop by determining whether a bridging contact of the elevator door lock is open or closed.

21. The method according to claim 20 wherein the checking of the defined depth of engagement is performed by actuation of an elevator control.
